(19) United States
(12) Patent Application Publication
(10) Pub. No.: US 2019/0220877 A1
(43) Pub. Date: Jul. 18, 2019

(54) COMPUTER-READABLE RECORDING MEDIUM, DEMAND FORECASTING METHOD AND DEMAND FORECASTING APPARATUS

(71) Applicant: FUJITSU LIMITED, Kawasaki-shi (JP)

(72) Inventors: Yuka JO, Kawasaki (JP); Isamu WATANABE, Kawasaki (JP)

(73) Assignee: FUJITSU LIMITED, Kawasaki-shi (JP)

(21) Appl. No.: 16/234,820

(22) Filed: Dec. 28, 2018

(30) Foreign Application Priority Data
Jan. 12, 2018 (JP) 2018-003743

(51) Int. Cl. G06Q 30/02; G06N 20/00

(52) U.S. Cl. CPC G06Q 30/0202; G06N 20/00

(57) ABSTRACT

A computer-readable recording medium has stored therein a program that causes a computer to execute a process including: learning, for multiple forecasting models that perform demand forecasting based on sales performance data, multiple error forecasting models that estimate forecasting errors of the respective forecasting models based on product information and a result of forecasts by the respective forecasting models based on sales performance data on a first period; generating weight information on the multiple forecasting models from forecasting errors of multiple forecasted values by the multiple forecasting models, which are forecasting errors generated using the multiple error forecasting models and based on the sales performance data on a second period, which is a period after the first period, and the product information; and performing demand forecasting based on the result of forecasts by the multiple forecasting models that are combined according to the weight information.

### CROSS-REFERENCE TO RELATED APPLICATION

This application is based upon and claims the benefit of priority of the prior Japanese Patent Application No. 2018-003743, filed on Jan. 12, 2018, the entire contents of which are incorporated herein by reference.

### FIELD

The embodiment discussed herein is generally related to a computer-readable recording medium, a demand forecasting method and a demand forecasting apparatus.

### BACKGROUND

As realization of highly accurate demand forecasting is the key to optimize supply chain management (SCM), demand forecasting to forecast future demand using old sales performance data has been performed conventionally.

The demand forecasting is performed by applying multiple forecasting methods (various models) to demand forecast data. In demand forecasting using multiple forecasting methods, a blend ratio of each of the multiple demand forecasting models that minimizes a forecasting error is calculated. A total demand forecasting apparatus that calculates an amount of forecasted demand using multiple forecasting methods based on the calculated blend ratios is known.

Patent Literature 1: Japanese Laid-open Patent Publication No. 2009-104408

Patent Literature 2: Japanese Laid-open Patent Publication No. 2013-131259

Patent Literature 3: Japanese Laid-open Patent Publication No. 2010-122825

In the conventional technology, however, various types of information on sales, such as product characteristics and lifecycle characteristics, are not applied to forecasting errors and, as a result, this may lower forecasting accuracy.

For example, when there are substantial fluctuations in the sales performance in the past due to a specific cause, errors of the multiple forecasting methods with respect to the sales performance in the past may be in a distribution different from that of errors of the multiple forecasting methods in a case without substantial fluctuations. In the above-described conventional technology, multiple forecasting methods are blended based on errors in the past and thus, when there are fluctuations in the sales performance in the past due to a specific cause, appropriate blending is sometimes not performed and thus the forecasting accuracy lowers.

### SUMMARY

According to an aspect of an embodiment, a non-transitory computer-readable recording medium has stored therein a program that causes a computer to execute a process including: learning, for multiple forecasting models that perform demand forecasting based on sales performance data, multiple error forecasting models that estimate forecasting errors of the respective forecasting models based on product information on a subject product and a result of forecasts by the respective forecasting models based on sales performance data on a first period; generating weight information on the multiple forecasting models from forecasting errors of multiple forecasted values by the multiple forecasting models, which are forecasting errors generated using the multiple error forecasting models and based on the sales performance data on a second period, which is a period after the first period, and the product information; and performing demand forecasting based on the result of forecasts by the multiple forecasting models that are combined according to the weight information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary functional configuration of a demand forecasting apparatus according to an embodiment of the present invention;

FIG. 2 is a flowchart exemplifying a first learning phase;

FIG. 3 is an explanatory diagram illustrating learning multiple forecasting models;

FIG. 4 is an explanatory diagram illustrating calculation of an average forecasting error;

FIG. 5 is a flowchart exemplifying a second learning phase;

FIG. 6 is an explanatory diagram illustrating learning an error forecasting model;

FIG. 7 is a flowchart exemplifying a forecasting phase;

FIG. 8 is an explanatory diagram illustrating periods corresponding to data that is used for the phases;

FIG. 9 is an explanatory diagram illustrating a result of comparison among forecasted values;

FIG. 10 is an explanatory diagram illustrating a result of comparison among forecasted values;

FIG. 11 is an explanatory diagram illustrating a result of comparison among forecasted values;

FIG. 12 is an explanatory diagram illustrating a result of comparison among forecasted values; and

FIG. 13 is an explanatory diagram illustrating an exemplary computer that executes a program.

### DESCRIPTION OF EMBODIMENT(S)

Preferred embodiments of the present invention will be explained with reference to accompanying drawings. Components having the same functions among the embodiments will be denoted with the same reference numbers and redundant descriptions will be omitted. The computer-readable recording media, the demand forecasting methods, and the demand forecasting apparatuses according to the embodiments below represent examples only and do not limit embodiments. The following embodiments may be combined properly as long as no inconsistency is caused.

About Configuration

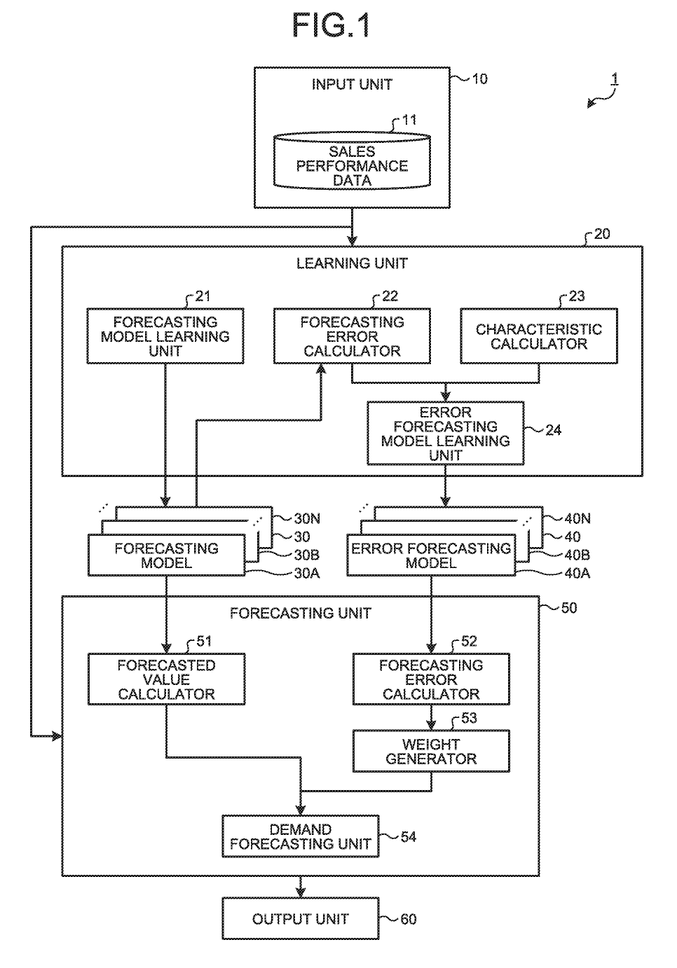

FIG. 1 is a block diagram illustrating an exemplary functional configuration of a demand forecasting apparatus according to an embodiment. As illustrated in FIG. 1, a demand forecasting apparatus 1 is an apparatus that includes an input unit 10, a learning unit 20, a forecasting unit 50 and an output unit 60 and that performs demand forecasting using sales performance data 11 that is input and utilizing multiple forecasting models 30.

The input unit 10 receives instruction data on demand forecasting (such as a forecasting period and products on which forecasting is performed) and the sales performance data 11 as input data and outputs the received input data to the learning unit 20 and the forecasting unit 50. The sales performance data 11 is data representing sales performance of each product and, for example, is data in which the sales figures of each product on each date of sale are described. As for the sales performance data 11, the input unit 10 outputs, to the learning unit 20, data in which the sales figures of each product corresponding to dates of sale in a first period are described. As for the sales performance data 11, the input unit 10 outputs, to the forecasting unit 50, data in which the sales figures of each product corresponding to dates of sale in a second period that is a period after the first period are described.

Products on which demand forecasting is performed may be any products, such as goods or services that are produced, circulated and exchanged in economic activities. For example, the embodiment exemplifies exemplary application to foods and housewares in a store, such as a supermarket. Alternatively, the product may be power supplied by a power company or services, such as postal delivery.

The learning unit 20 learns the multiple forecasting models 30 corresponding respectively to forecasting methods and by multiple error forecasting models 40 that estimate forecasting errors of the multiple forecasting models 30.

Based on the instruction data on demand forecasting (such as a forecasting period and products for which forecasting is performed), the forecasting unit 50 performs demand forecasting (makes a forecast of sales figures on each date of sale) on the products on which forecasting is performed. Specifically, the forecasting unit 50 performs demand forecasting on the products on which forecasting is performed in the forecasting period, based on the most recent sales performance data 11 on the second period and using the multiple forecasting models 30 and the multiple error forecasting models 40 for the respective multiple forecasting models 30.

The output unit 60 outputs the result of forecasting (demand forecasting) performed by the forecasting unit 50 as a display output to a display, as a print output to a paper medium, or the like, or as a file output.

About Learning

The learning unit 20 includes a forecasting model learning unit 21, a forecasting error calculator 22, a characteristic calculator 23 and an error forecasting model learning unit 24.

The forecasting model learning unit 21 performs learning by different multiple forecasting methods using part of the sales performance data 11 as learning data and constructs (generates) forecasting models 30A, 30B . . . 30N for the respective forecasting methods. The forecasting models 30A, 30B . . . 30N are regression models or the like that are constructed for the respective forecasting methods in order to calculate a demand forecast on a product from the most recent sales performance and are referred to as the forecasting models 30 when not particularly distinguished.

The multiple forecasting methods in the forecasting model learning unit 21 may be known methods that are prepared in advance to deal with various product characteristics. For example, the forecasting methods include naive forecasting (for example, forecasting the same value as the value of the same day of the previous week), exponential smoothing, ARIMA (Auto Regressive Integrated Moving Average), ARIMAX (ARIMA+regression), multiple linear regression, a generalized linear model (such as Gamma or Poisson) and a dynamic linear model.

The forecasting error calculator 22 calculates forecasting errors of the multiple forecasting models 30, using part of the sales performance data 11 (not overlapping the learning data) as calculation data (weight calculation data).

Specifically, the forecasting error calculator 22 uses the forecasting models 30 to calculate, for a period corresponding to the weight calculation data, forecasted values (values of demand forecasting) for the respective multiple forecasting models 30. The forecasting error calculator 22 then calculates forecasting errors of the multiple forecasting models by comparing the forecasted values for the forecasting models 30 with the (correct) weight calculation data.

The characteristic calculator 23 calculates characteristic information that is used as an explanatory variable when the error forecasting model learning unit 24 learns the error forecasting models 40 based on part of the learning data in the old sales performance data.

Specifically, the characteristic calculator 23 quantifies forecasting characteristics, static product characteristics, dynamic product characteristics, life cycle characteristics and the most recent error from the learning data.

The forecasting characteristics are characteristics that are calculated from forecasting requirements, such as the forecasting period to make a forecast, and, for example, includes the forecasting period and a model period. By using the forecasting period (for example, after N days) that is set when making a forecast as a numeric value, the characteristic calculator 23 obtains the forecasting characteristics for the forecasting period. By using the learning data period (for example, N days) that is used for the multiple forecasting models 30, the characteristic calculator 23 obtains forecasting characteristics for the model period.

The static product characteristics are product characteristics that are determined before the product is on sale and do not change. The characteristic calculator 23 obtains product characteristics for product classification by converting a classification code of each product in the sales performance data 11, or the like, into a dummy variable. The characteristic calculator 23 uses the price of each product (for example, X yen) directly as a numeric value or classifies the price (for example, between X yen to Y yen) to obtain the product characteristics for the price.

The dynamic product characteristics are product characteristics that change after sales, such as the sales interval and the average sales figures. The characteristic calculator 23 calculates a sales interval (such as every N days) in the learning data and uses the sales interval to obtain the product characteristics for the sales interval. The characteristic calculator 23 calculates the sales figures (for example, N) per day in the learning data and uses the sales figures to obtain product characteristics for the average sales figures.

The lifecycle characteristics are product characteristics that change according to the product lifecycle, such as the product phases (introduction stage/growth stage/maturity stage/decline stage). The characteristic calculator 23 obtains lifecycle characteristics by estimating the product phases (introduction stage/growth stage/maturity stage/decline stage) from the launch date information on the product in the learning data and the sales change of the product.

The most recent error is an average forecasting error, or the like, in the specified most recent period. The characteristic calculator 23 obtains the most recent error by calculating an average absolute error or an average absolute error rate in the learning data in the specified most recent period by using the forecasting models 30.

The forecasting characteristics and static product characteristics are characteristics that do not change with time. Thus, using the forecasting characteristics or the static characteristics as an explanatory variable to learn the error forecasting models 40, for example, enables generation of regression models that reduce the effect of statistical fluctuation.

The dynamic product characteristics and the lifecycle characteristics are characteristics that change gradually according to the lifecycle (time) of each product. Thus, using the dynamic product characteristics and the lifecycle characteristics as an explanatory variable to learn the error forecasting model 40 enables generation of a regression model that captures a change in the product characteristics corresponding to the lifecycle.

The most recent error is characteristics that represent an external cause, such as a trend that is difficult to explain by forecasting characteristics and product characteristics. Thus, using the most recent error as an explanatory variable to learn the error forecasting models 40 enables generation of regression models that capture an external cause, such as a trend.

The error forecasting model learning unit 24 learns, for the respective multiple forecasting models 30, error forecasting models 40A, 40B . . . 40N that estimate forecasting errors of the forecasting models 30 corresponding to the respective forecasting methods. The error forecasting models 40A, 40B . . . 40N are regression models, or the like, that are constructed in order to calculate forecasting errors of the respective forecasting methods from the most recent sales performance and will be referred to as the error forecasting models 40 when not particularly distinguished.

Specifically, the error forecasting model learning unit 24 uses a known machine learning technology, such as random forest, and uses, as an explanatory variable, the characteristic information on all the products that is calculated by the characteristic calculator 23 to learn the error forecasting models 40 that are regression models where the forecasting errors that are calculated by the forecasting error calculator 22 serve as an objective variable.

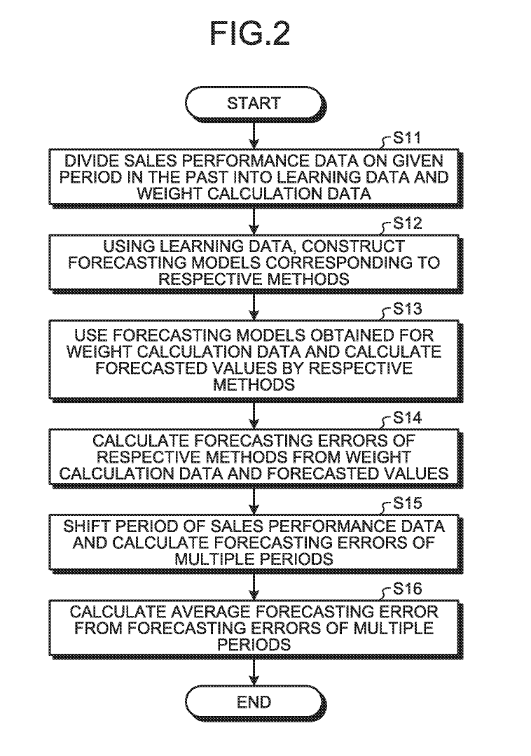

Details of learning by the learning unit 20 (a first learning phase and a second learning phase) will be described. First of all, the first learning phase in which the multiple forecasting models 30 are constructed and forecasting errors of the forecasting models 30 are calculated will be described. FIG. 2 is a flowchart exemplifying the first learning phase.

As illustrated in FIG. 2, when the first learning phase starts, the learning unit 20 divides the sales performance data 11 on a given period in the past into learning data and weight calculation data (S11). This data division is performed such that, in the combination of the learning data and weight calculation data, mutual data periods do not overlap.

Using the learning data, the forecasting model learning unit 21 constructs the forecasting models 30 corresponding to the respective methods (such as naive forecasting, exponential smoothing, ARIMA, ARIMAX, multiple linear regression, a generalized linear model and a dynamic linear model) (S12).

The forecasting error calculator 22 uses the forecasting models 30 that are obtained by the forecasting model learning unit 21 to calculate forecasted values (values of demand forecasting) by the respective methods with respect to the period of the weight calculation data (S13).

The forecasting error calculator 22 calculates forecasting errors of the respective forecasting methods corresponding to the multiple forecasting models 30 by comparing the (correct) weight calculation data and the forecasted values by the respective methods (S14).

The learning unit 20 shifts the period of the sales performance data 11 and repeats the process at steps S11 to S14 to calculate forecasting errors of multiple periods (S15). The forecasting error calculator 22 calculates, for the forecasting errors of the respective forecasting methods corresponding respectively to the multiple forecasting models 30, an average forecasting error from the forecasting errors of the multiple periods (S16) and ends the process.

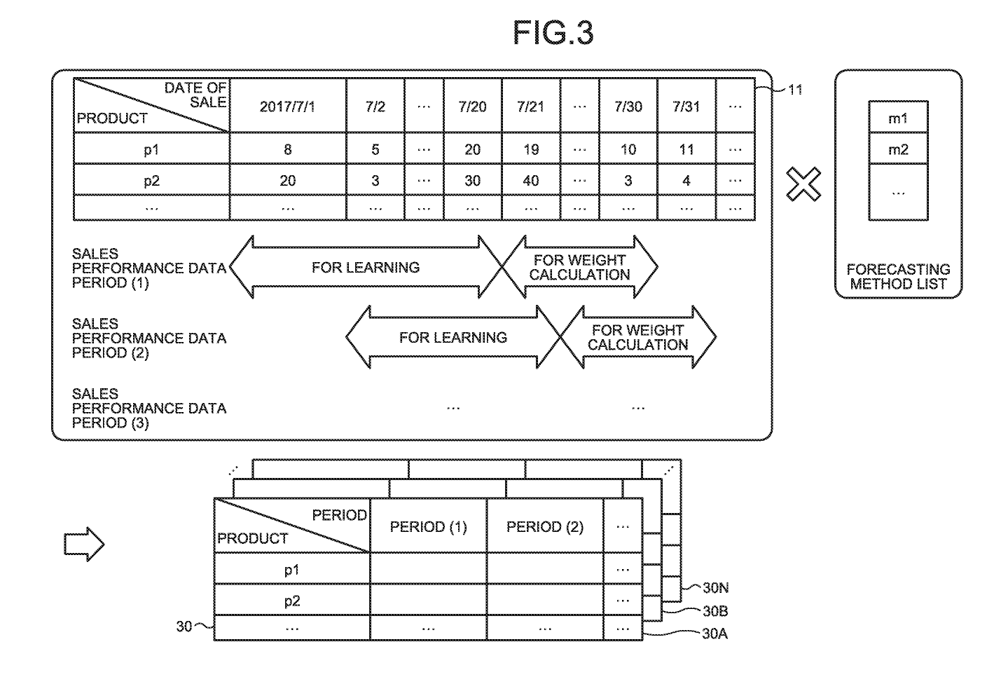

FIG. 3 is an explanatory diagram illustrating learning the multiple forecasting models 30. As illustrated in FIG. 3, by using the learning data in the sales performance data 11, the forecasting model learning unit 21 constructs (learns) the forecasting models 30 corresponding to the forecasting methods in the forecasting method list (m1, m2 . . . ). Specifically, by learning shifted periods of the sales performance data 11, such as Period (1), Period (2) . . . , the forecasting model learning unit 21 learns the forecasting models 30 for calculating demand forecasts (sales figures) on the products (p1, p2 . . . ) in each period.

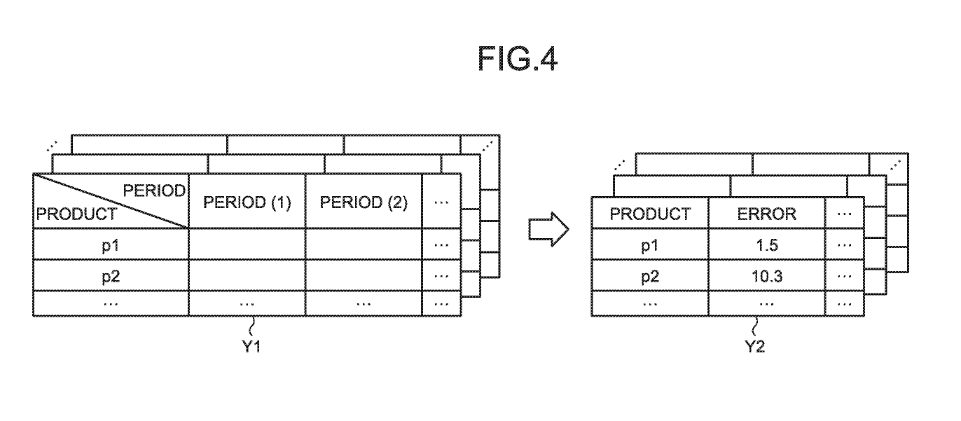

FIG. 4 is an explanatory diagram illustrating calculation of an average forecasting error. As illustrated in FIG. 4, by comparing a forecasted value in a period of the weight calculation data, which is calculated by applying the forecasting model 30 corresponding to each of the forecasting methods, with correct data, the forecasting error calculator 22 obtains a forecasting error Y1 of each period by each forecasting method. By calculating an average from the forecasting errors Y1 of Period (1), Period (2) . . . , the forecasting error calculator 22 obtains an average forecasting error Y2 of each forecasting method.

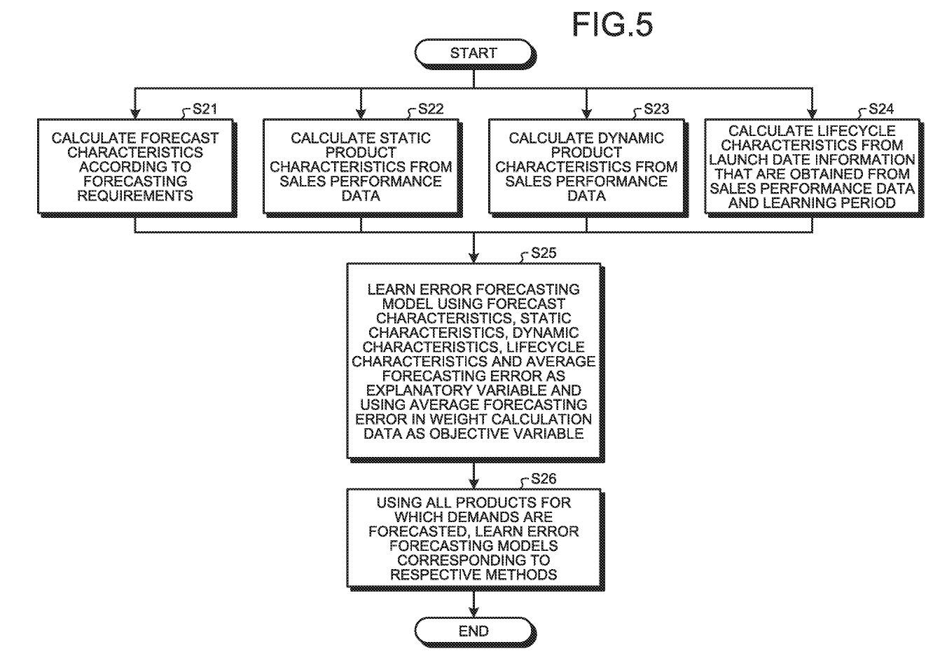

The second learning phase in which the multiple error forecasting models 40 for the respective multiple forecasting models 30 are learned will be described. FIG. 5 is a flowchart exemplifying the second learning phase.

As illustrated in FIG. 5, when the second learning phase is started, the characteristic calculator 23 calculates characteristic information based on part of the learning data in the old sales performance data 11 (S21 to S24).

Specifically, the characteristic calculator 23 calculates forecasting characteristics according to the forecasting requirements (for example, a forecasting period and a model period) that are previously determined (S21). The characteristic calculator 23 calculates static product characteristics (for example, product classification and price) from the sales performance data 11 (S22). The characteristic calculator 23 calculates dynamic product characteristics (for example, a sales interval and average sales figures) from the sales performance data 11 (S23). The characteristic calculator 23 calculates lifecycle characteristics (product phase (introduction stage/growth stage/maturity stage/decline stage)) from launch date information on the product and a sales change in the learning period of the product that are obtained from the sales performance data 11 (S24).

The error forecasting model learning unit 24 uses the characteristic information, which is calculated by the characteristic calculator 23, as an explanatory variable and learns the error forecasting models 40 that are regression models where the forecasting errors that are calculated by the forecasting error calculator 22 serve as an objective variable (S25).

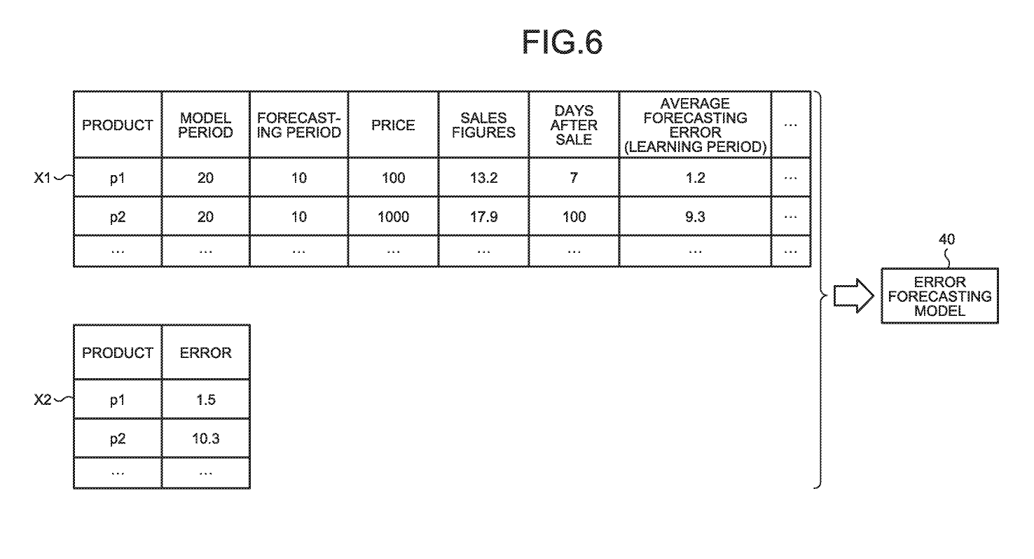

FIG. 6 is a diagram illustrating learning the error forecasting model 40. As illustrated in FIG. 6, for each product (p1, p2 . . . ), the error forecasting model learning unit 24 uses the forecasting characteristics (the model period and forecasting period), the static product characteristics (price), the dynamic product characteristics (sales figures), the lifecycle characteristics (days after sale) and the average forecasting error as an explanatory variable X1.

Furthermore, for each product (p1, p2 . . . ), the error forecasting model learning unit 24 uses the average forecasting error in the weight calculation data that is calculated by the forecasting error calculator 22 as an objective variable X2. The error forecasting model learning unit 24 learns the error forecasting model 40 by regression analysis using a known machine learning technology, such as random forest, based on the explanatory variable X1 and the objective variable X2.

The learning unit 20 repeatedly performs the process at S21 to S25 using all products for which demands are forecasted for each of the forecasting models 30. Accordingly, for the respective multiple forecasting models 30, the learning unit 20 learns the multiple error forecasting models 40 that estimate forecasting errors of the respective forecasting methods (S26).

About Forecasting

Refer back to FIG. 1. The forecasting unit 50 includes a forecasted value calculator 51, a forecasting error calculator 52, a weight generator 53 and a demand forecasting unit 54.

By applying the multiple forecasting models 30 to the most recent sales performance data 11, the forecasted value calculator 51 calculates, for a subject product that is specified as a product for which demand is to be forecast, forecasted values (values of demand forecasting) by the respective forecasting methods.

By applying the multiple error forecasting models 40 to the most recent sales performance data 11, the forecasting error calculator 52 calculates, for a product that is specified as a subject product for which demand is to be forecast, forecasting errors by the respective forecasting methods in the multiple forecasting models 30.

Based on the forecasting errors of the respective forecasting methods in the multiple forecasting models 30, the weight generator 53 generates weight information to weight the forecasted values by the respective multiple forecasting models 30. Specifically, the weight generator 53 generates, for a forecasted value by the forecasting model 30 with a large forecasting error, a weight value whose degree of contribution to integration of the forecasted values by the respective multiple forecasting models 30 is small. The weight generator 53 generates, for a forecasted value by the forecasting model 30 with a small forecasting error, a weight value whose degree of contribution to integration of the forecasted values by the respective multiple forecasting models 30 is large. The weight value may be a value that depends on whether the forecasting error is negative or positive and, for example, a negative amount that results in a penalty may be set.

The demand forecasting unit 54 perform demand forecasting based on a result of forecasting by the combined multiple forecasting models 30 according to the weight information that is generated by the weight generator 53. Specifically, the demand forecasting unit 54 performs, for the forecasted values by the respective multiple forecasting models 30 that are calculated by the forecasted value calculator 51, weighted accumulation in which the forecasted values are selected or synthesized based on the weight information that is generated by the weight generator 53. The demand forecasting unit 54 then outputs the result of the weighted accumulation as a result of the forecast on the subject product for which demand is to be forecast (for example, sales figures).

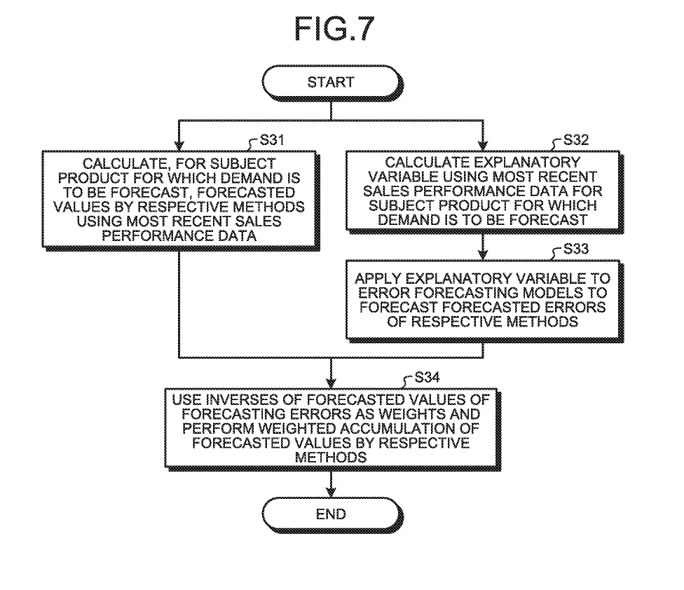

Details of forecasting performed by the forecasting unit 50 (forecasting phase) will be described in detail. FIG. 7 is a flowchart exemplifying the forecasting phase.

As illustrated in FIG. 7, when the forecasting phase is started, the forecasted value calculator 51 calculates, for the subject product for which demand is to be forecast, forecasted values by the respective forecasting methods using the most recent sales performance data 11 (S31).

Using the most recent sales performance data 11 for the subject product for which demand is to be forecast, the forecasting error calculator 52 calculates an explanatory variable (characteristic information on the subject product) for application to the error forecasting model 40 (S32). By calculating an explanatory variable in the same manner as that taken by the characteristic calculator 23, for example, forecasting characteristics, static product characteristics, dynamic product characteristics, lifecycle characteristics and the most recent error are calculated.

The forecasting error calculator 52 then applies the calculated explanatory variable to the multiple error forecasting models 40 to forecast (calculate) forecasting errors of the respective forecasting methods (S33). Based on the calculated forecasting errors of the respective forecasting methods, the weight generator 53 generates weight information to weight the forecasted values by the respective multiple forecasting models 30.

Based on the generated weight information, the demand forecasting unit 54 uses inverses of the forecasted values of the forecasting errors as weights and performs weighted accumulation of the forecasted values by the respective forecasting methods (S34). Accordingly, the demand forecasting unit 54 outputs the result of weighted accumulation as a result of the forecast on the subject product for which demand is to be forecast and ends the process.

The weighted accumulation is not limited to the above-described method in which, for the forecasted values by the multiple forecasting models 30, the inverses of the forecasting errors in the weight information are used as weight values and the forecasted values are multiplied by the inverses and then integrated. For example, for the forecasted values by the multiple forecasting models 30, when the weight value in the weight information is equal to or larger than a given threshold, the forecasted value is multiplied by 1 and, when the weight value is smaller than the threshold, the forecasted value is multiplied by 0 and then the forecasted values may be integrated.

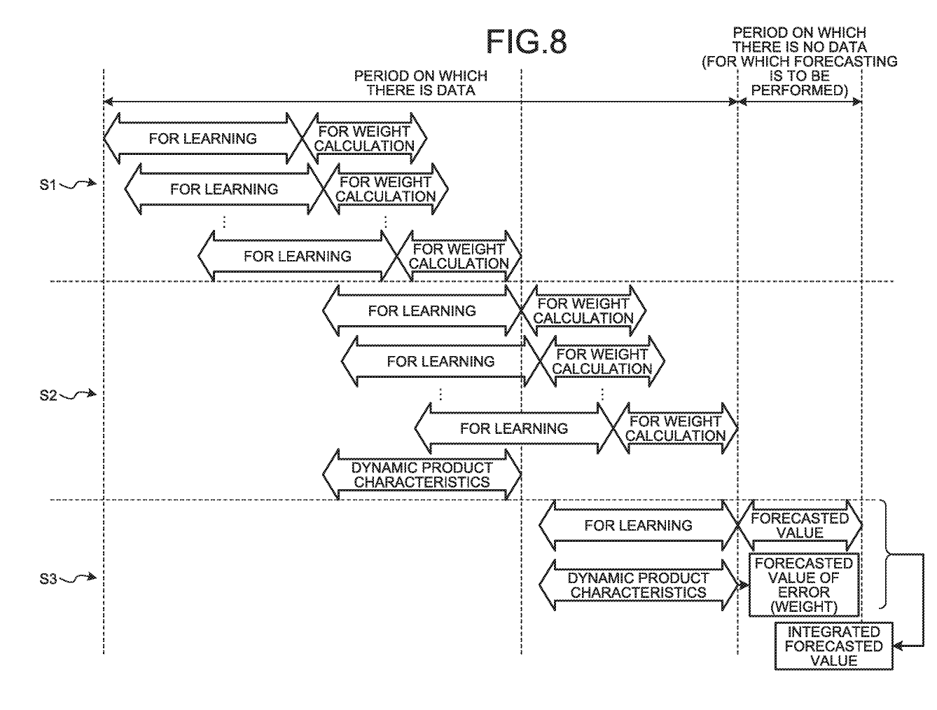

FIG. 8 is an explanatory diagram illustrating periods corresponding to data that is used for the phases. As illustrated in FIG. 8, as for the first learning phase (S1) and the second learning phase (S2), the periods corresponding to the learning data and the weight calculation data in a pair do not overlap. As for the forecasting phase (S3), after the first and second phases, data closest to a period on which forecasting is to be performed, which is data on a period on which there is data, is used to calculate forecasted values by the respective forecasting methods and forecasted values of errors (weights). In the forecasting phase, an integrated forecasted value is calculated by performing weighted accumulation on the forecasted values by the respective forecasting methods.

About Effect

As described above, the demand forecasting apparatus 1 includes the learning unit 20, the weight generator 53 and the demand forecasting unit 54. For the respective multiple forecasting models 30 that perform demand forecasting based on the sales performance data 11, based on the product information on the subject product and based on the result of forecasts by the respective forecasting models 30 based on the sales performance data 11 on the first period, the learning unit 20 learns the error forecasting models 40 that estimate forecasting errors of the respective forecasting models 30. The weight generator 53 generates weight information on the multiple forecasting models 30 from the forecasting errors of forecasted values by the multiple forecasting models 30, which are forecasting errors generated using the multiple error forecasting models 40 and based on the sales performance data 11 on the second period, which is a period after the first period, and the product information. The demand forecasting unit 54 performs demand forecasting based on the result of forecasts by the multiple forecasting models 30 that are combined according to the weight information generated by the weight generator 53.

As described above, based on the product information on the product for which demand is to be forecasted and the sales performance data, the demand forecasting apparatus 1 learns the multiple error forecasting models 40 that estimate forecasting errors of the multiple forecasting models 30. Accordingly, in the error forecasting models 40 after learning, various types of information on sales including the product characteristics and the lifecycle characteristics that are represented by the sales performance data 11 are applied to the forecasting errors. When performing demand forecasting, the demand forecasting apparatus 1 weights the results of forecasts by the multiple forecasting models 30 from the forecasting errors calculated by the multiple error forecasting models 40 to perform demand forecasting. Thus, it is possible to perform highly-accurate demand forecasting.

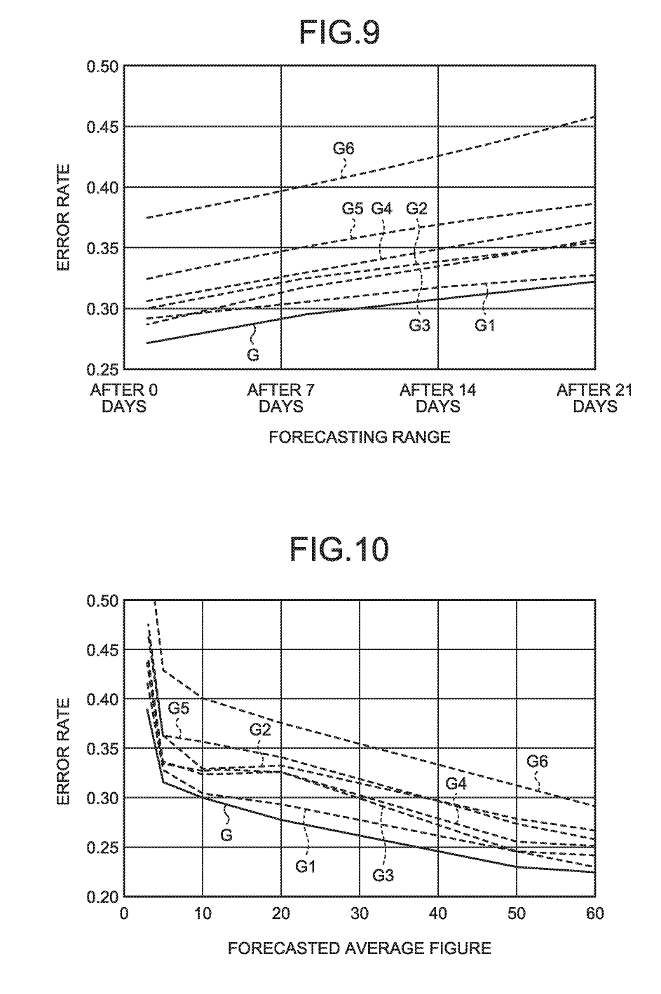

FIG. 9 and FIG. 10 are explanatory diagrams each illustrating a result of comparison among forecasted values. Specifically, FIG. 9 is a diagram representing Graphs G and G1 to G6 where the horizontal axis represents the forecasting range and the vertical axis represents the error rate. Furthermore, FIG. 10 is a diagram representing Graphs G and G1 to G6 where the horizontal axis represents the forecasted average figure and the vertical axis represents the error rate.

Graph G represents forecasted values calculated by the demand forecasting apparatus 1 according to the embodiment. Graph G1 represents forecasted values by ARIMAX. Graph G2 represents forecasted values by ARIMA. Graph G3 represents forecasted values by exponential smoothing. Graph G4 represents forecasted values by multiple linear regression. Graph G5 represents forecast values by the dynamic linear model. Graph G6 represents forecast values by naive forecasting.

As it is clear from comparison among Graphs G1 to G6 in FIGS. 9 and 10, the accurate forecasting method differs depending on various circumstances (the forecasting range and the forecasted average figure) about sales. For example, when the forecasting range is short, the exponential smoothing represented by Graph G3 is accurate. When the forecasting range is long, while naive forecasting represented by Graph G6 increase errors significantly, ARIMAX represented by Graph G1, etc., maintain high accuracy (a low error rate) even when the forecasting range is long. ARIMA represented by Graph G2 that has relatively high accuracy when the forecasted average figure is small increases the error rate compared to other methods when the forecasted average figure is large.

As described above, the highly-accurate forecasting method differs according to an increase or decrease in forecasting range and in forecasted average figure. For example, when the forecasting range is short and the forecasted average figure is small, which one of ARIMAX represented by Graph G1 and exponential smoothing represented by Graph G3 is selected? As described above, the forecasting method that should be selected differs depending on which of the forecasting range and the forecasted average figure the selection is based.

In the embodiment, learning, for the respective multiple forecasting models 30, the multiple error forecasting models 40 that estimate forecasting errors enables application of various circumstances about the sales to each of the forecasting errors. Thus, performing weighting on the result of forecasts by the multiple forecasting models 30 from forecasting errors calculated by the multiple error forecasting models 40 and performing demand forecasting enable demand forecasting with a low error rate as represented by Graph G.

The learning unit 20 learns the error forecasting models 40 using, as an explanatory variable, at least the product characteristics and the lifecycle characteristics of the product for which demand is to be forecast based on the sales performance data 11 on the first period and using, as an objective variable, forecasting errors of the forecasting models 30. As the explanatory variable contains the lifecycle characteristics, in the demand forecasting apparatus 1, the forecasting errors contain dynamic changes in the product characteristics and this enables more highly accurate demand forecasting.

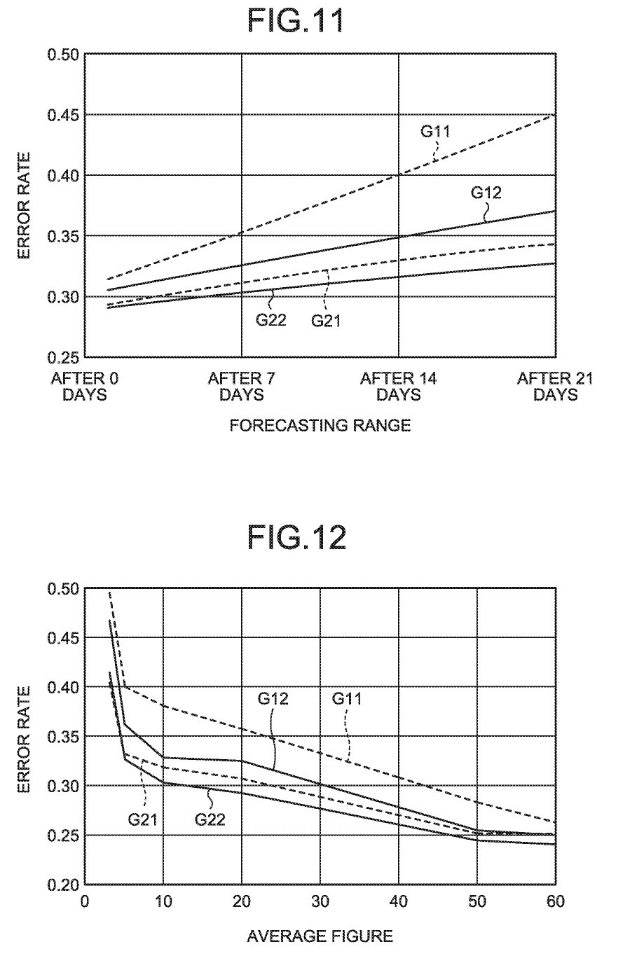

FIGS. 11 and 12 are explanatory diagrams each illustrating a result of comparison among forecasted values. Specifically, FIG. 11 is a diagram representing Graphs G11, G12, G21 and G22 where the horizontal axis represents the forecasting range and the vertical axis represents the error rate of forecasted values. FIG. 12 is a diagram representing Graphs G11, G12, G21 and G22 where the horizontal axis represents the forecasted average figure and the vertical axis represents the error rate.

Graphs G11 and G12 represent forecasted values by multiple linear regression, the model period of Graph G11 consists of 34 days and the model period of Graph G12 consists of 69 days. Graphs G21 and G22 represent forecasted values by ARIMAX, the model period of Graph G21 consists of 34 days and the model period of Graph G22 consists of 69 days.

As it is clear from comparison between Graph G11 and Graph G12 or between Graph G21 and Graph G22 in FIGS. 11 and 12, the difference in model period causes a difference in error rate among forecasting methods. For example, the shorter the model period is, the larger the error rate is. Furthermore, it can be estimated that ARIMAX represented by Graphs G21 and G22 have smaller effects of the difference in model period on the error rate than that of multiple liner regression represented by Graphs G11 and G12 and thus it can be concluded that ARIMAX is a forecasting method with less effect on the error rate due to a difference in model period and is less affected by the lifecycle. This example deals with a product with less change in lifecycle and the error rate is large when the model period is short; however, as for a product with fast lifecycle change, the error rate may lower as the model period increases.

In the embodiment, the explanatory variable to learn the multiple error forecasting models 40 contains the lifecycle characteristics and this enables application of dynamic changes in product characteristics to forecasting errors. Thus, weighting on the result of forecasts by the multiple forecasting models 30 according to the lifecycle enables highly accurate demand forecasting.

### OTHER EMBODIMENTS

Each component of each apparatus need not necessarily be configured physically as illustrated in the drawings. In other words, specific modes of distribution and integration in each apparatus are not limited to those illustrated in the drawings and all or part of the components can be configured by being distributed and integrated physically or functionally in a given unit according to various loads and usage.

All or given part of various processing functions that are performed by the demand forecasting apparatus 1 may be executed on a CPU (or a microcomputer, such as a MPU or a micro controller unit (MCU)). Needless to say, all or given part of the various functions may be executed on a program that is analyzed and executed by a CPU (or a microcomputer, such as a MPU or a MCU) or on hardware using a wired logic. Multiple computers may cooperate to execute the various processing functions, which are performed by the demand forecasting apparatus 1, by cloud computing.

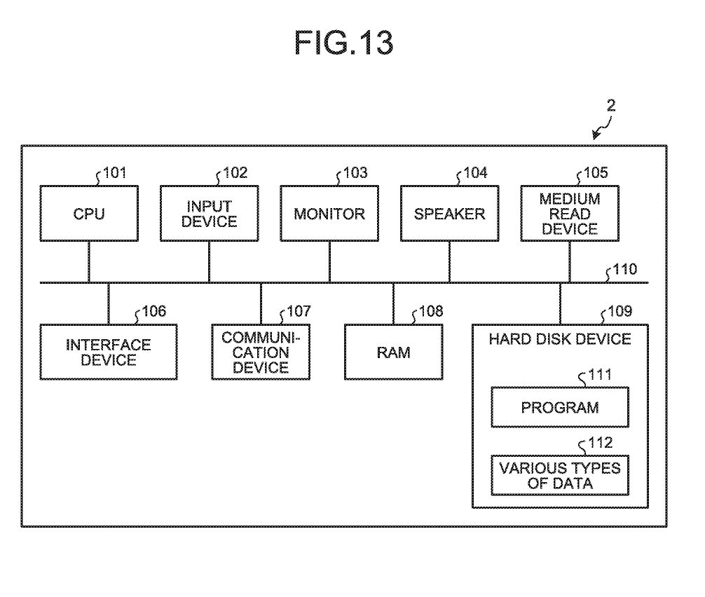

Various types of processes that are described in the above-described embodiment can be realized by executing a program that is prepared in advance by a computer. An exemplary computer (hardware) that executes a program having the same functions as those of the above-described embodiment will be described below. FIG. 13 is an explanatory diagram illustrating an exemplary computer that executes a program.

As illustrated in FIG. 13, a computer 2 includes a CPU 101 that executes various types of computation, an input device 102 that receives data inputs, a monitor 103 and a speaker 104. The computer 2 includes a medium read device 105 that reads a program, etc., from a storage medium, an interface device 106 for connection with various devices, and a communication device 107 for wired or wireless connection for communication with external devices. The computer 2 includes a RAM 108 that temporarily stores various types of information and a hard disk device 109. Each component (101 to 109) in the computer 2 is connected to a bus 110.

In the hard disk device 109, is stored a program 111 for executing various processes performed by the function units, such as the input unit 10, the learning unit 20, the forecasting unit 50 and the output unit 60 that are described in the above-described embodiment. In the hard disk device 109, various types of data 112, such as the forecasting models 30 and the error forecasting models 40, that the program 111 refers is stored. The input device 102 receives inputs of operation information from the operator of the computer 2. The monitor 103, for example, displays various screens that the operator operates. To the interface device 106, for example, a printing device, etc., are connected. The communication device 107 is connected to a communication network, such as a local area network (LAN), and communicates various types of information with external devices via the communication network.

The CPU 101 reads the program 111 that is stored in the hard disk device 109, loads the program 111 into the RAM 108 and executes the program 111 to perform the various processes relating to the input unit 10, the learning unit 20, the forecasting unit 50 and the output unit 60. The program 111 need not be stored in the hard disk device 109. For example, the computer 2 may read the program 111 that is stored in a readable storage medium and execute the program. The storage medium that is readable by the computer 2, for example, corresponds to a portable recording medium, such as a CD-ROM, a DVD disk or a universal serial bus (USB) memory, a semiconductor memory, such as a flash memory, a hard disk drive, or the like. The program 111 may be stored in a device that is connected to a public line, the Internet, a LAN, or the like, and the computer 2 may read the program 111 from the device and execute the program.

According to the embodiment of the present invention, it is possible to perform highly accurate demand forecasting.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
learning, for multiple forecasting models that perform demand forecasting based on sales performance data, multiple error forecasting models that estimate forecasting errors of the respective forecasting models based on product information on a subject product and a result of forecasts by the respective forecasting models based on sales performance data on a first period;
generating weight information on the multiple forecasting models from forecasting errors of multiple forecasted values by the multiple forecasting models, which are forecasting errors generated using the multiple error forecasting models and based on the sales performance data on a second period, which is a period after the first period, and the product information; and
performing demand forecasting based on the result of forecasts by the multiple forecasting models that are combined according to the weight information.

2. The non-transitory computer-readable recording medium according to claim 1, wherein the learning includes learning the error forecasting models using, as an explanatory variable, at least product characteristics and lifecycle characteristics of the subject product based on the product information and the sales performance data on the first period and using, as an objective variable, the forecasting errors of the forecasting models.

3. The non-transitory computer-readable recording medium according to claim 1, wherein the generating includes generating weight information on the multiple forecasting models based on inverses of forecasting errors of the multiple forecasted values by the multiple forecasting models.

4. A demand forecasting method comprising:
learning, for multiple forecasting models that perform demand forecasting based on sales performance data, multiple error forecasting models that estimate forecasting errors of the respective forecasting models based on product information on a subject product and a result of forecasts by the respective forecasting models based on sales performance data on a first period, by a processor;
generating weight information on the multiple forecasting models from forecasting errors of multiple forecasted values by the multiple forecasting models, which are forecasting errors generated using the multiple error forecasting models and based on the sales performance data on a second period, which is a period after the first period, and the product information, by the processor; and
performing demand forecasting based on the result of forecasts by the multiple forecasting models that are combined according to the weight information, by the processor.

5. The demand forecasting method according to claim 4, wherein the learning includes learning the error forecasting models using, as an explanatory variable, at least product characteristics and lifecycle characteristics of the subject product based on the product information and the sales performance data on the first period and using, as an objective variable, the forecasting errors of the forecasting models.

6. The demand forecasting method according to claim 4, wherein the generating includes generating weight information on the multiple forecasting models based on inverses of forecasting errors of the multiple forecasted values by the multiple forecasting models.

7. A demand forecasting apparatus comprising a processor that executes a process comprising:
learning, for multiple forecasting models that perform demand forecasting based on sales performance data, multiple error forecasting models that estimate forecasting errors of the respective forecasting models based on product information on a subject product and a result of forecasts by the respective forecasting models based on sales performance data on a first period;
generating weight information on the multiple forecasting models from forecasting errors of multiple forecasted values by the multiple forecasting models, which are forecasting errors generated using the multiple error forecasting models and based on the sales performance data on a second period, which is a period after the first period, and the product information; and
performing demand forecasting based on the result of forecasts by the multiple forecasting models that are combined according to the weight information.

8. The demand forecasting apparatus according to claim 7, wherein the learning includes learning the error forecasting models using, as an explanatory variable, at least product characteristics and lifecycle characteristics of the subject product based on the product information and the sales performance data on the first period and using, as an objective variable, the forecasting errors of the forecasting models.

9. The demand forecasting apparatus according to claim 7, wherein the generating includes generating weight information on the multiple forecasting models based on inverses of forecasting errors of the multiple forecasted values by the multiple forecasting models.
